(19) United States
(12) Patent Application Publication
(10) Pub. No.: US 2014/0260828 A1
(43) Pub. Date: Sep. 18, 2014

(54) MULTI-SIZE ADJUSTABLE SLEEVE

(71) Applicant: A-TINA TOOLS CO., LTD., Taichung City (TW)

(72) Inventor: Kun-Chen CHEN, Taichung City (TW)

(73) Assignee: A-TINA TOOLS CO., LTD., Taichung City (TW)

(21) Appl. No.: 13/796,571

(22) Filed: Mar. 12, 2013

(51) Int. Cl. B25B 13/16

(52) U.S. Cl. CPC B25B 13/16
USPC 81/163

(57) ABSTRACT

A multi-size adjustable sleeve has a sleeve body, a controlling unit, and a fixing unit. The sleeve body has a wheel slit formed through the sleeve body. The controlling unit is mounted in the sleeve space and has a wheel, two screw columns, and two clamping plates. The wheel is set in the sleeve body and protrudes out of the wheel slit. The screw columns are connected with the wheel and have reverse thread directions. The clamping plates are movably mounted on the screw columns. The sleeve can adjust the distance between the clamping plates by rotating the wheel, such that the sleeve can be applied for bolts or nuts of different sizes.

### BACKGROUND OF THE INVENTION

1. Field of the Invention

The present invention relates to a sleeve, and more particularly to a multi-size adjustable sleeve.

2. Description of Related Art

A wrench is applied for fastening or loosening bolts or nuts. Generally, the wrench is manufactured in a fixed size, and therefore is only applicable for bolts or nuts of certain sizes. The wrench cannot be connected with the bolt or the nut whose size does not match the size of the wrench, and under such a circumstance the wrench has to be replaced with another wrench to match the bolt or the nut in other different sizes.

In addition, a sleeve is provided to increase convenience of operating a wrench. With reference to FIG. 9, a wrench 70 has a handle 71 and a connecting head 72. The handle 71 is elongated, and the connecting head 72 is connected with an end of the handle 71. Multiple sleeves 80 that have different sizes are respectively provided to apply for the wrench 70. In use, one of the sleeves 80 that matches the bolt or the nut is connected with the connecting head 72. The sleeves 80 are usually placed in a sleeve box 90 for carriage. As the amount and the sizes of the sleeves 80 are large, the sleeve box 90 is heavy and bulky.

### SUMMARY OF THE INVENTION

The main objective of the present invention is to provide a multi-size adjustable sleeve comprising a sleeve body, a controlling unit and a fixing unit.

The sleeve body has two sides, a connecting portion formed in one of the ends of the sleeve body, a sleeve space formed in the sleeve body and having a space opening in one of the ends that is opposite to the connecting portion, and at least one wheel slit formed through the sleeve body.

The controlling unit is mounted in the sleeve space and protrudes out of the space opening and has a wheel, two screw columns, and two clamping plates. The wheel is mounted rotatably in the sleeve space and protrudes from the at least one wheel slit, and has two sides, a periphery, and a central direction. The screw columns are connected with the wheel and are respectively located at the two sides of the wheel. Each screw column has a thread direction. The thread directions of the screw columns are reverse from each other.

The clamping plates are each respectively and moveably mounted on the screw columns, and protrude from the space opening. Each clamping plate has two sides, a column segment located in the sleeve space, a screw hole formed in the column segment such that the clamping plate is mounted around the corresponding screw column via the screw hole, at least one abutted portion protruding from the column segment, and a clamping segment connected with the column segment. The fixing unit is mounted on the sleeve body and abuts the abutted portions of the clamping plates.

The sleeve can adjust the distance between the clamping plates by rotating the wheel. When the wheel is rotated, the screw columns are each respectively driven to rotate with respect to the rotatable axes. The thread directions of the screw columns are reverse to each other, such that the clamping plates are driven to approach or separate from each other depending on the combining relationship between the screw holes and the screw columns. As a result, the sleeve can be applied for bolts or nuts of different sizes and provides a high convenience for use.

### BRIEF DESCRIPTION OF THE DRAWINGS

FIG. 1 is a perspective view of a preferred embodiment of a multi-size adjustable sleeve in accordance with the present invention;

FIG. 2 is an exploded perspective view of the sleeve in FIG. 1;

FIG. 3 is a side view in partial section of the sleeve in FIG. 1;

FIG. 4 is an enlarged cross sectional side view of the wheel of the sleeve in FIG. 3;

FIG. 5 is a cross sectional side view of the sleeve in FIG. 1;

FIG. 6 is a cross sectional top view of the sleeve across Line 6-6 in FIG. 5;

FIG. 7 is an operational perspective view of the sleeve in FIG. 1;

FIG. 8 is an operational cross sectional top view of the sleeve in FIG. 1; and

FIG. 9 is a perspective view of conventional sleeves and a wrench.

### DETAILED DESCRIPTION OF PREFERRED EMBODIMENT

With reference to FIG. 1 and FIG. 2, a preferred embodiment of a multi-size adjustable sleeve in accordance with the present invention has a sleeve body 10, a controlling unit 20, and a fixing unit 30.

With reference to FIG. 2, FIG. 3, FIG. 4 and FIG. 5, the sleeve body 10 has two ends, a connecting portion 11, a sleeve space 12, two wheel slits 13, and two pin troughs 14. The connecting portion 11 is formed in one of the ends of the sleeve body 10 and can be connected with a wrench. In the preferred embodiment, the connecting portion 11 may have a hole for connection with the wrench. The sleeve space 12 is formed in the sleeve body 10 and has a space opening 121 in one of the ends that is opposite to the connecting portion 11. The wheel slits 13 are elongated, are formed through two opposite sides of the sleeve body 10, face each other, and communicate with the sleeve space 12 and the space opening 121. One of the wheel slits 13 may be omitted, such that only a wheel slit 13 is implemented. The pin troughs 14 are elongated, are concaved inside but are un-through the sleeve body 10, face each other, and communicate with the sleeve space 12 and the space opening 121.

The controlling unit 20 is mounted in the sleeve space 12 and protrudes out of the space opening 121 and has a wheel 21, two screw columns 22, and two clamping plates 23. The wheel 21 is round, is mounted rotatably in the sleeve space 12 and protrudes from at least one of the wheel slits 13. In the preferred embodiment, the wheel 21 protrudes from both of the wheel slits 13. The wheel 21 has two sides, a central direction 211 and multiple wheel troughs 212. The wheel 21 can be rotated with respect to the central direction 211. The wheel troughs 212 are formed in and arranged annularly around the periphery of the wheel 21 and are parallel with the central direction 211 of the wheel 21, such that a user can rotate the wheel 21 easily via the wheel troughs 212.

The screw columns 22 are connected with the wheel 21 along the central direction 211 and are each respectively located at the sides of the wheel 21. Each screw column 22 has a rotating axis 221, a pin 222, and a thread direction. Preferably, the screw column 22 is co-axial with the wheel 21 as the rotating axis 221 and the central direction 211 are on the same line. The pins 222 are formed on ends of the screw columns 22 opposite to the wheel 21 and are each respectively accommodated in the pin troughs 14. The thread directions are reverse from each other.

Alternatively, the screw columns 22 are parallel with the central direction 211 of the wheel 21 but are not co-axial with the wheel. Therefore, the wheel 21 is rotated eccentrically with respect to the screw columns 22, and then the screw columns 22 are fixed at the pin troughs 14 and driven to rotate with the wheel 22.

The clamping plates 23 are each respectively and moveably mounted on the screw columns 22 and protrude from the space opening 121. Each clamping plate 23 has two sides, a column segment 231, a screw hole 232, at least one abutted portion 233, a clamping segment 234, and a groove 235. The column segment 231 is located in the sleeve space 12. The screw hole 232 is formed through the column segment 231 such that the clamping plate 23 is mounted around the corresponding screw column 22 via the screw hole 232. When the wheel 21 is rotated, the screw columns 22 are driven to rotate and the clamping plates 23 move to approach or separate from each other by the reverse thread directions. The column segment 231 is provided with at least one abutted portion 233. Preferably, each clamping plate 23 has two abutted portions 233, the two abutted portions 233 each respectively protruding from the two sides of the corresponding column segment 231. The clamping segment 234 is connected with the column segment 231 and protrudes out of the space opening 121. Preferably, the clamping segment 234 is concaved to form a V-shaped cross section. The groove 235 is elongated and is formed along a middle portion of the clamping segment 234.

The fixing unit 30 is mounted on the sleeve body 10 and abuts the abutted portions 233 to keep the clamping plates 23 from falling off the sleeve space 12. Preferably, the fixing unit 30 is annular and is mounted on one of the ends of the sleeve body 10 that is opposite to the connecting portion 11. The fixing unit 30 is mounted on the sleeve body 10 by four fixing bolts 31 and has two fixing unit troughs 32. The fixing unit troughs 32 are formed in the fixing unit 30 and communicate with the wheel slits 13 respectively to keep the annular fixing unit 30 from interfering with the wheel 21.

With reference to FIG. 5, FIG. 6, and FIG. 7, in use, the connecting portion 11 connects with a wrench 40. The wheel 21 is rotated to drive the screw column 22 to rotate, such that the clamping plates 23 are driven to separate from each other. The clamping plates 23 clamp a bolt 50, and then the wheel 21 is rotated in reverse such that the clamping plates 23 approach each other to tightly clamp the bolt 50. The wrench 40 is rotated to fasten or loosen the bolt 50 on an object 51 via the sleeve.

With reference to FIG. 6 and FIG. 8, the distance between the clamping plates 23 can be adjusted by rotating the wheel 21 to achieve multi-size applicability. When the wheel 21 is rotated, the clamping plates 23 can be separated from or approached each other. As a result, the sleeve can be applied for bolts or nuts of different sizes. A box equipped with conventional sleeves of different sizes is no longer needed to be carried; the sleeve in accordance with the present invention provides high convenience for use.

What is claimed is:

1. A multi-size adjustable sleeve comprising:
a sleeve body having
two ends;
a connecting portion formed in one of the ends of the sleeve body;
a sleeve space formed in the sleeve body and having a space opening in one of the two ends that is opposite to the connecting portion; and
at least one wheel slit formed through the sleeve body;
a controlling unit mounted in the sleeve space and protruding out of the space opening and having
a wheel mounted rotatably in the sleeve space and protruding from the at least one wheel slit, and having
two sides;
a periphery; and
a central direction;
two screw columns connected with the wheel and respectively located at the two sides of the wheel, wherein each screw column has a thread direction, wherein the thread directions of the screw columns are reverse from each other; and
two clamping plates each respectively and moveably mounted on the screw columns and protruding from the space opening, wherein each clamping plate has
two sides;
a column segment located in the sleeve space;
a screw hole formed in the column segment such that the clamping plate is mounted around the corresponding screw column via the screw hole;
at least one abutted portion protruding from the column segment; and
a clamping segment connected with the column segment; and
a fixing unit mounted on the sleeve body and abutting the abutted portions of the clamping plates.

2. The multi-size adjustable sleeve as claimed in claim 1, wherein
each clamping segment is concaved to form a V-shaped cross section and has a middle portion; and
each clamping plate further has a groove being elongated and formed along the middle portion of the clamping plate.

3. The multi-size adjustable sleeve as claimed in claim 2, wherein the wheel further has multiple wheel troughs formed in and arranged annularly around the periphery of the wheel.

4. The multi-size adjustable sleeve as claimed in claim 3, wherein the wheel troughs are parallel with the central direction of the wheel.

5. The multi-size adjustable sleeve as claimed in claim 4, wherein the fixing unit is annular and is mounted on one of the ends of the sleeve body that is opposite to the connecting portion.

6. The multi-size adjustable sleeve as claimed in claim 5, wherein
the sleeve body has two wheel slits facing each other and communicating with the space opening; and
the fixing unit further has two fixing unit troughs formed in the fixing unit and each respectively communicating with the wheel slits of the sleeve body.

7. The multi-size adjustable sleeve as claimed in claim 6, wherein each clamping plate has two abutted portions respectively protruding from the two sides of the corresponding clamping plate and abutting the fixing unit.

8. The multi-size adjustable sleeve as claimed in claim 7, wherein the fixing unit is mounted on the sleeve body by multiple fixing bolts.

9. The multi-size adjustable sleeve as claimed in claim 1, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

10. The multi-size adjustable sleeve as claimed in claim 2, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

11. The multi-size adjustable sleeve as claimed in claim 3, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

12. The multi-size adjustable sleeve as claimed in claim 4, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

13. The multi-size adjustable sleeve as claimed in claim 5, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

14. The multi-size adjustable sleeve as claimed in claim 6, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

15. The multi-size adjustable sleeve as claimed in claim 7, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.

16. The multi-size adjustable sleeve as claimed in claim 8, wherein
the sleeve body further has two pin troughs being elongated, facing each other, concaved inside the sleeve body, and communicating with the sleeve space and the space opening; and
each screw column further has a pin formed on an end of the screw column opposite to the wheel, wherein the pins of the screw columns are each respectively accommodated in the pin troughs of the sleeve body.
